(19) United States
(12) Patent Application Publication
(10) Pub. No.: US 2022/0413688 A1
(43) Pub. Date: Dec. 29, 2022

(54) Seamless Content Presentation

(71) Applicant: Scrollmotion, Inc. dba Ingage, Yardley, PA (US)

(72) Inventors: Benjamin Guy, Nashville, TN (US); James Rutherford, Nanaimo (CA)

(73) Assignee: Scrollmotion, Inc. dba Ingage, Yardley, PA (US)

(21) Appl. No.: 17/355,865

(22) Filed: Jun. 23, 2021

(51) Int. Cl. G06F 3/0484; G06F 16/438; G06F 3/0482; G06F 16/18

(52) U.S. Cl. CPC G06F 3/04842; G06F 16/4393; G06F 3/04847; G06F 3/0482; G06F 16/1873

(57) ABSTRACT

The disclosure provides for methods and systems, including computer-readable storage media encoded with a computer program, for generating a composite content presentation from a primary presentation and multiple sub-presentations. The sub-presentations and the primary presentation can be presented seamlessly in the composite presentation with a common appearance through at least some common display elements, such as a navigation bar, appearing across each presentation. Some display elements, such as the navigation bar, may be controlled by the author of the composite presentation, while other display elements unique to each sub-presentation may be controlled by the author of the sub-presentation.

### BACKGROUND

Content presentation software refers to software for generating, editing, and displaying content presentations. A content presentation can include one or more types of content, for example text, video, or images, which can be displayed to an audience to accompany the presentation of some topic. Content presentations can be organized into slides, pages, or other logical units of organization. Content presentation software can provide tools for digitally creating and editing content presentations, as well as provide additional tools for displaying the content when ready for presentation.

### BRIEF SUMMARY

Aspects of the disclosure provide methods and systems, including computer-readable storage media, for generating a seamless composite content presentation from a primary presentation and at least one sub-presentation. The system includes at least one processor to link the at least one sub-presentation together with the primary presentation and to display each of the primary presentation and the sub-presentations with common display elements, such as a common navigation bar or color scheme. The author of the composite presentation can control the look and feel of the common display elements, which can create the appearance that the composite presentation is one seamless presentation instead of a collection of multiple presentations. Each of the primary and sub-presentations can be generated using a common template. The system can be configured to fetch up-to-date versions of each sub-presentation of a composite presentation, when the composite presentation is selected for display. The system provides a flexible interface for modifying a composite presentation, allowing a composite presentation to be generated at the direction of a first user creating the composite presentation from sub-presentations provided by other users of the system.

In one embodiment, the system allows for content and stylistic changes to a composite presentation, while also allowing sub-presentation authors to maintain some degree of autonomy over their work. The system can receive and maintain display criteria and permissions for each sub-presentation, which are enforced during the generation of a composite presentation. The display criteria specify how content may be modified and displayed when a presentation is made part of a composite presentation, while different permissions can specify whether the sub-presentation is available to be linked into other presentations at all, and if so under specified conditions as described herein. In this embodiment, sub-presentations can be generated to include common display elements that are available for modification by a composite presentation author but can also be generated to include sub-presentation specific display elements which are not subject to change by the composite presentation author.

In one embodiment, a system including at least one processor is configured to: receive a primary presentation and at least one sub-presentation; and generate a composite presentation from the primary presentation and the at least one sub-presentation, wherein the at least one processor links the primary presentation to the at least one sub-presentation and generates data for displaying the composite presentation, including data for displaying at least one display element in common across the primary presentation and the at least one sub-presentation.

In one embodiment, a method includes receiving, by at least one processor, a primary presentation and at least one sub-presentation; and generating, by the at least one processor, a composite presentation from the primary presentation and the at least one sub-presentation, including linking the primary presentation to the at least one sub-presentation and generating data for displaying the composite presentation, including data for displaying at least one display element in common across the primary presentation and the at least one sub-presentation.

In one embodiment, a non-transitory computer-readable storage medium encoded with a computer program, the program including instructions that when executed by at least one processor, cause the at least one processor to perform operations including: receiving a primary presentation and at least one sub-presentation; and generating a composite presentation from the primary presentation and the at least one sub-presentation, wherein the at least one processor links the primary presentation to the at least one sub-presentation and generates data for displaying the composite presentation, including data for displaying at least one display element in common across the primary presentation and the at least one sub-presentation.

The foregoing the other embodiments can each optionally include one or more of the following features.

The at least one processor generates the data for displaying the composite presentation based on composite presentation display criteria specifying modifications to the at least one display element in common across the primary presentation and the at least one sub-presentation.

The at least one processor displays, on a display device, at least a portion of the composite presentation according to the generated data and based on the one or more composite presentation display criteria.

To display at least a portion of the composite presentation, the at least one processor: receives a version of a sub-presentation of the at least one sub-presentation identified as the most recent version of the sub-presentation; and displays the composite presentation using at least the generated data and the received version of the sub-presentation.

The at least one display element for each of the at least one sub-presentation and the primary presentation is arranged according to a common template.

The common template includes a display element including a navigation bar, the navigation bar including one or more user-interactable elements for navigating between the at least one sub-presentation or the primary presentation in the composite presentation.

To generate data for displaying the composite presentation, the at least one processor modifies at least one sub-presentation in the composite presentation according to the one or more composite presentation display criteria.

The at least one processor receives, for at least one of the at least one sub-presentation, one or more sub-presentation display criteria specifying conditions for displaying content of the at least one sub-presentation; and wherein to generate the data for displaying the composite presentation subject to the one or more composite presentation display criteria, the at least one processor: determines that generating the data does not violate the one or more sub-presentation display criteria for the at least one sub-presentation, and in response to the determination, generates data for displaying the composite presentation that does not violate the one or more sub-presentation display criteria for the at least one sub-presentation.

The at least one processor maintains, for each of the at least one sub-presentation, one or more respective permissions for generating a composite presentation including the at least one sub-presentation; and wherein to generate the composite presentation, the at least one processor determines, for a first sub-presentation of the at least one sub-presentation, whether generating the composite presentation with the received sub-presentation violates one or more maintained permissions for the first sub-presentation.

The primary presentation and each of the at least one sub-presentation are authored by one or more respective users, and wherein the one or more maintained permissions for the first sub-presentation indicate one or more permitted users for generating the composite presentation including the first sub-presentation.

The at least one processor maintains a plurality of composite presentations for download; receives a request to download a first composite presentation of the plurality of composite presentations; and in response, sends data for displaying the first composite presentation to a display device.

To link the primary presentation to at least one other sub-presentation, the at least one processor receives input indicating a position and a destination content presentation for a user-interactable presentation link in the composite presentation, wherein the user-interactable presentation link, in response to input, is configured to cause the at least one processor to display at least a portion of the destination content presentation specified in the input.

The at least one processor: maintains data corresponding to the composite presentation, specifying one or more of: the number of times the composite presentation was a response to a request to download the composite presentation, and the number of times the composite presentation was linked from another composite presentation of the maintained plurality of composite presentations.

### BRIEF DESCRIPTION OF THE DRAWINGS

FIG. 1 is a block diagram of an example content presentation system, according to aspects of the disclosure.

FIG. 2 is an example computing environment implementing the content presentation system, according to aspects of the disclosure.

FIG. 3 is a flowchart of an example process for generating and displaying a composite presentation.

FIG. 4A is a diagram of an example slide from a composite presentation, according to aspects of the disclosure.

FIG. 4B is a block diagram of a composite presentation, according to aspects of the disclosure.

FIG. 5 is a flowchart of an example process for modifying a composite presentation according to sub-presentation display criteria and permissions, according to aspects of the disclosure.

FIG. 6 illustrates example modifications of sub-presentations from a user library to a composite presentation, according to aspects of the disclosure.

FIG. 7 shows an example user interface for modifying a composite presentation, according to aspects of the disclosure.

FIG. 8 shows an example user interface for adding a presentation link to a composite presentation, according to aspects of the disclosure.

FIG. 9 shows an example user interface for viewing and searching a library of sub-presentations maintained by the system, according to aspects of the disclosure.

FIG. 10A shows an example user interface 1000A for viewing content presentations shared with teams on the system, according to aspects of the disclosure.

FIG. 10B shows an example user interface for viewing presentations of a user, according to aspects of the disclosure.

### DETAILED DESCRIPTION

### Overview

Aspects of the disclosure provide for creating and managing content presentations, including composite presentations from a primary presentation and one or more sub-presentations. A content presentation can include data representing content, and data for how that content is displayed, for example on a display of a device in receipt of the content presentation. A content presentation can include content of any of a variety of different forms, including text, video, images, multimedia content, animations, etc. The content can be included in a presentation according to any of a variety of different techniques, for example by a URL added to the presentation linking to content hosted on another device, or embedded in the content presentation itself. A content presentation can be organized into discrete logical units, which can include pages or slides as in a slide show presentation.

When the content presentation is displayed, at least a portion of a page or slide can be displayed at a time. The organization and order of content appearing in different pages or slides can vary depending on the purpose of the content presentation. A content presentation system as described herein can receive user input for creating and modifying a content presentation. The user input can reflect aesthetic and functional decisions made by the author of the content presentation for how the content presentation is meant to be used, for example to present on a particular topic to an audience.

In this specification, a composite content presentation (or “composite presentation”) is a content presentation that includes a primary presentation and one or more sub-presentations. A primary presentation can be a content presentation authored by the author-user of the composite presentation to be generated. The primary presentation can include one or more slides from which sub-presentations of the composite presentation are linked from. A sub-presentation is a content presentation that may or may not be authored by the same author as the author of a composite presentation. The designation of sub-presentation is relative to the role of the content presentation in the composite presentation. For example, a content presentation may be a first composite presentation including a number of first sub-presentations. At the same time the content presentation may be a sub-presentation itself to a second composite presentation, along with a number of other sub-presentations.

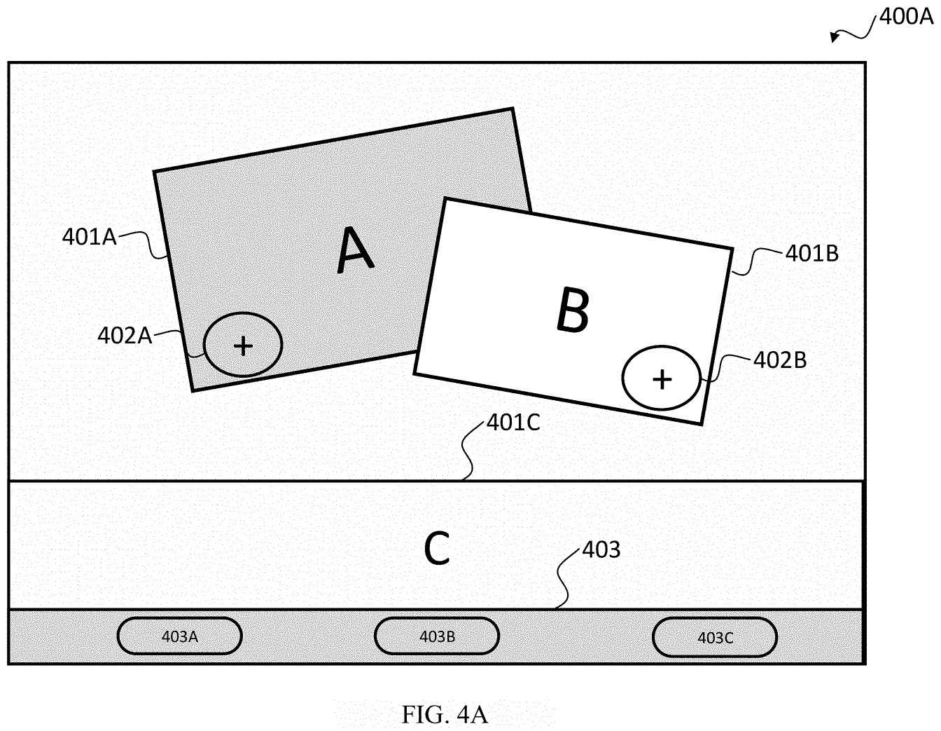

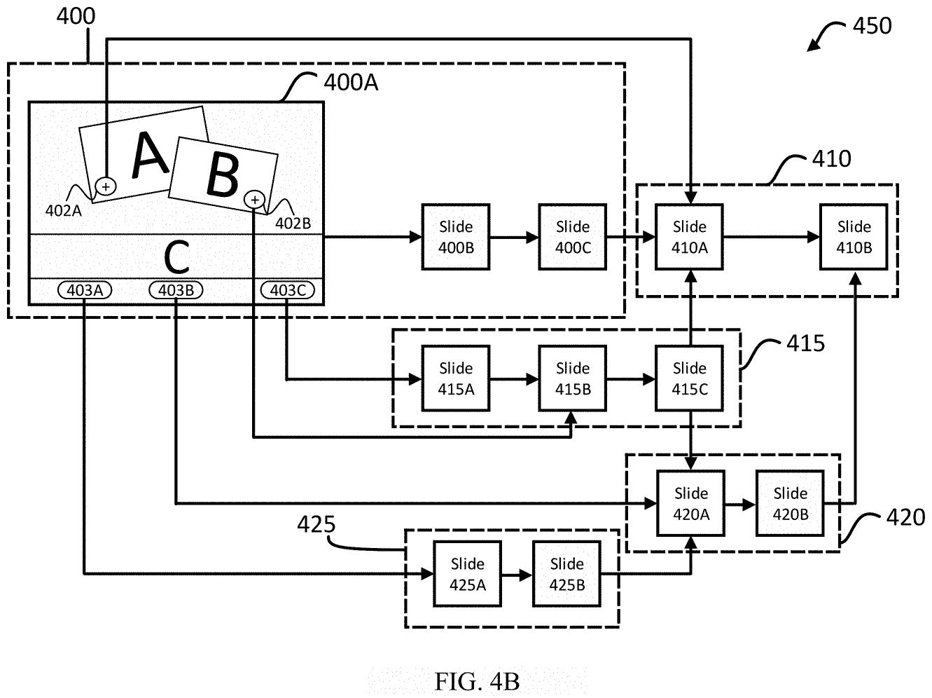

To connect content presentations together, the system is configured to generate one or more presentation links between each sub-presentation and/or each sub-presentation and the primary presentation. The system is also configured to provide a user interface for receiving input for generating, modifying, and tracking data related to the use of each presentation link, as described herein. Presentation links can be interactable elements, e.g., a button, scroll wheel, arrow, etc., that are included in one or more locations of the content presentation when the content presentation is displayed, for example through a display pane as shown and described herein with reference to FIG. 4A.

Presentation links allow for a non-linear progression of a composite presentation, such as by providing different branches during the presentation that a content presentation system as described herein can be configured to display in response to receiving input from those presentation links. As shown and described in more detail with reference to FIG. 4B, the use of one or more presentation links within a composite presentation can create a number of different paths a composite presentation can progress through. When the composite presentation is displayed and used, for example, as a tool to drive a discussion between a presenter and an audience, presentation links can be placed at different points in the composite presentation and accessed in relation to the discussion driven by the composite presentation.

One challenge in creating a composite presentation of content presentations from different authors is to create a content presentation which, from the perspective of an audience viewing the composite presentation, appears to have been prepared by a single author or group of authors working together. When authors of different content presentations are part of different organizations and/or have different goals for providing and presenting content, creating a “seamless” composite from these different content presentations can be difficult. At the same time, the use of a composite presentation can be important, for example in presenting on a complex project in which different parts of the project are managed by different authors.

Another challenge in creating a composite presentation of multiple content presentations is maintaining up-to-date versions of the primary and/or sub-presentations that make up at least part of a composite presentation. Because a composite presentation is made up of presentations by different, unrelated, authors, when one sub-presentation is updated, a content presentation at least partially using that sub-presentation must be modified as well to reflect any changes, which is otherwise out-of-date until those changes are made.

Aspects of the disclosure provide for a system configured to manage the creation and display of composite presentations using display criteria provided by both composite presentation authors and sub-presentation authors. The system provides an interface for receiving input for generating, modifying, and displaying composite presentations according to user input, for example from a composite author. The user input can include composite presentation display criteria that specifies how common display elements, such as a navigation bar, should appear across each sub-presentation when displayed as part of the composite presentation. The system can receive user input from the author of the composite presentation for modifying common display elements. The system can manage a repository of different authored content presentations, and allow users of the system to generate a composite presentation by linking one or more sub-presentations together.

By linking presentations together as described herein, aspects of the disclosure also eliminate the need to maintain separate files of separate presentations, at least because presentations can be automatically presented in an up-to-date version in response to user input at a presentation link. This can also eliminate, for example, the need to separately close and open multiple presentations in response to, for example, conversation from an audience viewing a presentation prompting the presenter to go into unpredicted topics with corresponding presentations. Instead, the composite presentation can be organized to create branches of sub-presentations, each sub-presentation corresponding to a different topic, for example.

Aspects of the disclosure can also provide for managing permissions and display criteria for sub-presentations provided by users of the system for use on a content presentation system implemented, as described herein. Content presentation authors can specify conditions for allowing their presentations to form part of sub-presentations for other users, including permitting or blocking certain users from using or accessing a published sub-presentation. In other examples, users can specify, for their sub-presentations, criteria for what may or may not be changed by a composite presentation author. For example, a sub-presentation may allow for certain display elements, like color schemes or the position of certain content items when displayed during a composite presentation, but prohibit the modification of the content itself. Sub-presentations using a common template with common display elements, e.g., a navigation bar, can automatically allow for modification of those common display elements from user input received by the system from a composite presentation author.

In this way, aspects of the disclosure provide for a system of managing content presentations to facilitate a seamless combination of content presentations authored by different authors who may be unrelated to one another. The system provides customization options for modifying a composite presentation to generate a composite presentation that appears to have been created with the collaboration of the various authors of the sub-presentations, while also allowing for sub-presentation authors to maintain some level of autonomy over their presentation.

The system can provide templates that can be used for generating sub-presentations forming part of a composite presentation. In some examples, the system provides for modification of a composite presentation according to a common template, while also determining whether sub-presentation specific display criteria are violated.

Aspects of the disclosure also provide for maintaining different versions of a content presentation, and providing a most recent version of a content presentation as part of a composite presentation. A device, such as a user computing device, can maintain one or more composite presentations that are kept up-to-date, for example by periodic comparison of presentations stored on the device, with presentations maintained in a database by a content presentation system. When a content presentation is selected for display, for example through a user interface implemented by a computing device, the device can determine whether the most recent version of the presentation is available on the device, and if not, retrieve the most updated version. A user can provide updated versions of a content presentation to the system, which in turn can provide the updated presentation to all composite presentations that include the content presentation as a sub-presentation. In this way, users authoring different content presentations that form a composite presentation can do so in parallel and without requiring coordination among the various users.

### Example Systems

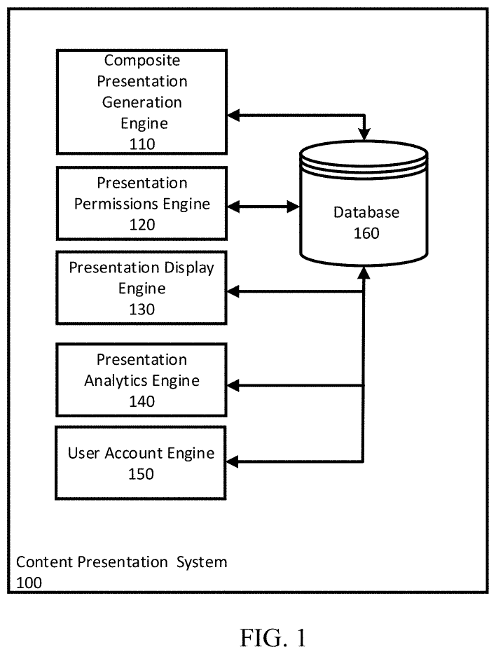

FIG. 1 is a block diagram of an example content presentation system 100, according to aspects of the disclosure. The content presentation system can include a composite presentation generation engine 110, a presentation permissions engine 120, a presentation display engine 130, a presentation analytics engine 140, and a user account engine 150. The system 100 can also include a database 160.

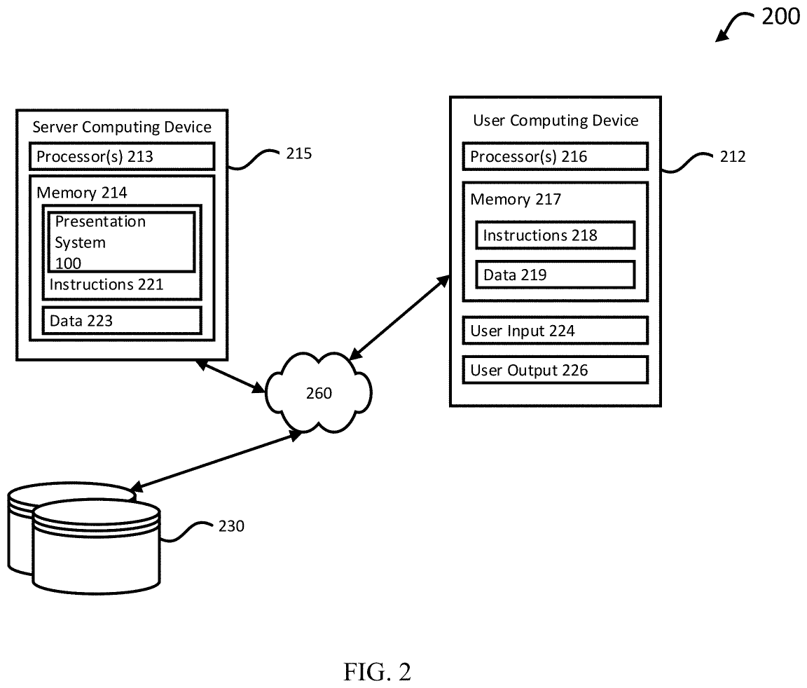

The system 100 can be implemented on one or more computing devices in one or more physical locations. For example, the system 100 can be implemented as part of an example computing environment 200, described herein with reference to FIG. 2. The system 100 is configured to generate content presentations each authored by one or more users of the system 100. The system 100 can maintain the database 160 which can include user account data for users registered with the system 100. Each user is associated with data defining a respective user account and, among other things, indications of different content presentations that the user has authored or has access to view, edit, or include in their own composite presentations.

Users of the system 100 can include, for example, individuals, enterprises, organizations, and automated software configured to interact with the system 100, for example by providing input to the system and receiving output from the system 100. An enterprise or organization can include one or more other enterprises, organizations, individuals, or automated software associated with one or more user accounts. The system 100, for example through the user account engine 150, can maintain data corresponding to different users and corresponding user accounts for each user. Users can be grouped in a number of different ways, for example by authorship, e.g., users that have co-authored a content presentation, or by association predetermined in response to user input.

Users of the system can also be organized into sub-groups of larger organizations or enterprises, as an example. For example, a user can refer to a team of individuals in an organization, and the organization itself can be represented on the system as a collection of different user accounts, each user account corresponding to a team. Teams can be separated, for example, based on department or function within an organization, or by physical region, although in general teams can follow a composition according to any criteria conducive for its individual members or the organization or enterprise corresponding to that team.

For example, the user account engine 150 can receive input through a user interface specifying that one or more user accounts are associated under a common group or sub-group. User accounts can be organized into groups and sub-groups within those groups arbitrarily, according to user input. The user account engine 150 can maintain permissions corresponding to different users and groups of users. These permissions can relate to who is part of a respective group, and what rights a user has to modify data related to the group, such as adding new users or removing current members.

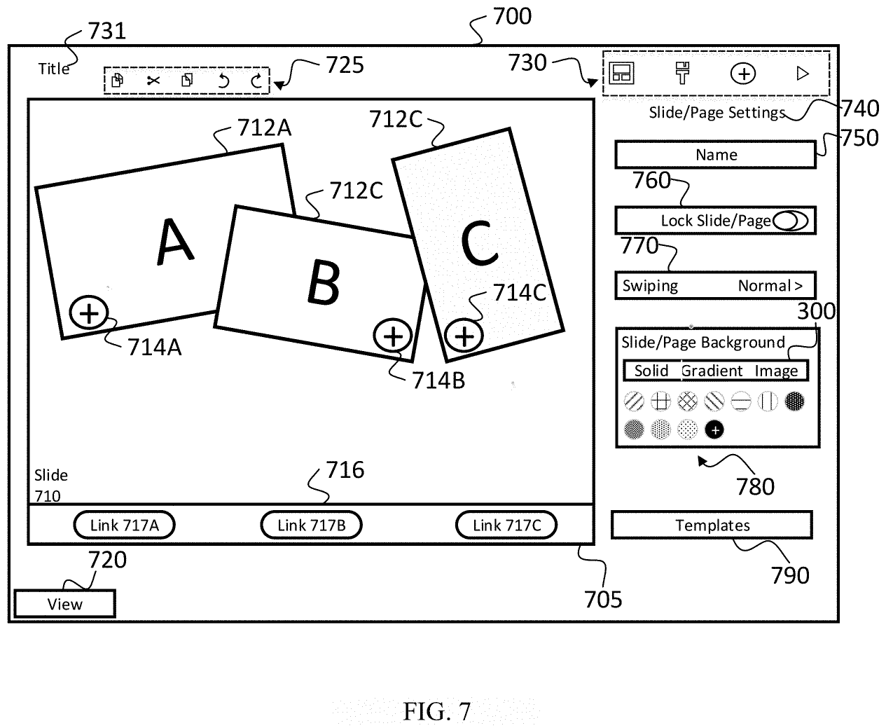

The composite presentation generation engine 110 can be configured to generate and edit content presentations on the system, through a user interface, such as a graphical user interface. The system 100 can include a user interface that can be accessed, for example, through one or more web pages hosted by a server. In some examples, the user interface is implemented as a dedicated software application, installed on a user computing device in communication with the system 100. Examples of the user interface are provided herein, with reference to FIGS. 7-10B.

Through the user interface, the generation engine 110 can receive input for generating a content presentation. The input can include one or more items of content, such as text, images, sound clips, videos etc., as well as include data specifying how the content presentation is to be displayed. The generation engine 110 can generate data from input specifying one or more templates or predefined arrangements of content provided by the system or other users of the system 100. The generation engine 110 can also receive input specifying additions, deletions, and/or changes to one or more display elements for the content presentation.

Display elements can refer to any part of a feature of a content presentation for arranging or displaying content or user-interactable elements of the presentation. A user-interactable element can include an element on a user interface or a content presentation that can receive input, for example through touch-input, mouse-click, or any other form of user input as described herein and with reference to FIG. 2. The system allows for customization of these different display elements, which can include a color scheme, a transition effect from one portion of a presentation displayed to another portion, fonts for content items including text, and different effects for animating one or more items of content within the presentation.

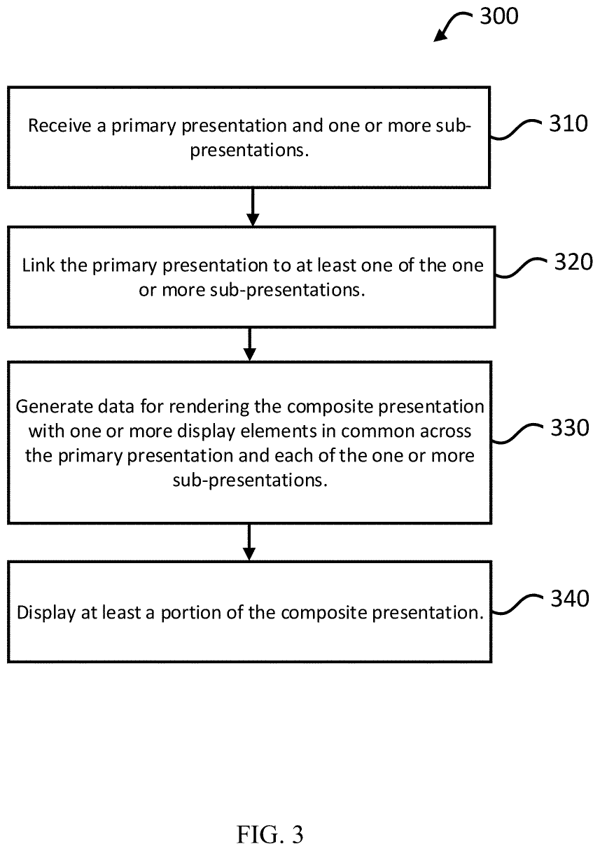

The templates or arrangements can include display elements such as a navigation bar, or a common color scheme across pages or slides of the content presentation using the template. The template can include one or more display elements that a sub-presentation author includes with their sub-presentation, for example, to allow for modification by the author of a composite presentation using the sub-presentation. As described herein, the system provides for balancing control between authors for their sub-presentations, with authors using those sub-presentations as part of creating a composite presentation. A template, as described in more detail with reference to FIG. 3, can allow for sub-presentations to be more easily integrated into composite presentations, to provide a seamless appearance during presentation.

The generation engine 110, upon generating a content presentation in response to user input, can cause the content presentation to be saved at the database 160. The user account engine 150, for example, can generate data relating the created content presentation with a user account of a user authoring the content presentation.

The generation engine 110 can associate one or more users as authors of a generated content presentation. For example, authorship can be determined by the user account logged into the user interface at the time a request for generating a content presentation is made. The generation engine 110 can receive input specifying a list of users to associate as authors of the content presentation. The user account engine 150 can maintain data corresponding to the different content presentations stored in the database 160, with respective users associated as authors for the content presentations.

Upon generating a content presentation, the system 100 can prompt a user, through the user interface, to publish or save the content presentation. The system 100 can save the content presentation to the database 160, as well as metadata, including data identifying the author or authors of the content presentation, the time of creation or last edit of the content presentation, etc. The system 100, in response to a prompt to publish the content presentation, can make the content presentation available to at least some other users of the system 100.

The generation engine 110, in addition to generating a content presentation, can be configured to receive input to generate, modify and/or publish a composite presentation. The generation engine 110 can receive, as input, a primary presentation and one or more sub-presentations, for example specified by a user of the system 100 through user input at a user interface. The primary presentation can be a content presentation authored by the user. The sub-presentations can include content presentations authored by the user, as well as content presentations authored by one or more other users of the system 100. An example process for generating the composite presentation is provided herein with reference to FIG. 3.

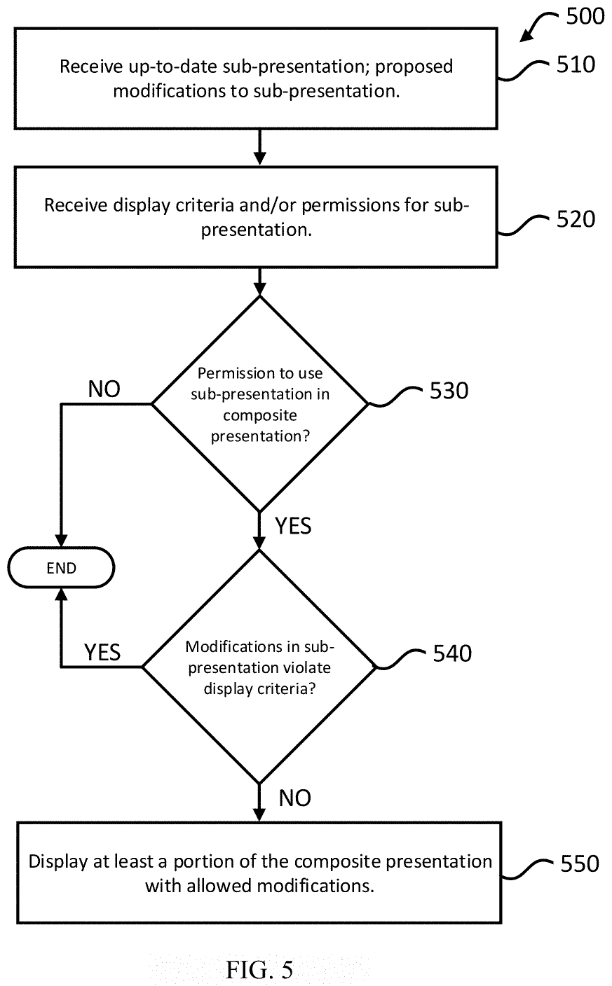

As described herein with reference to FIG. 5, the system 100 can receive one or more permissions and/or one or more display criteria for displaying a content presentation. The permissions can be maintained and updated by the presentation permissions engine 120. Permissions can refer to, for example, a list of approved or blocked users, as well as approved or blocked actions that other users of the system 100 can take related to the published content presentation. For example, for a published content presentation, the presentation permissions engine 120 can receive data indicating that only a subset of users of the system 100 can include the published presentation in their own authored composite presentations. In some examples, the permissions specify allowing or blocking certain slides or pages of a content presentation from being edited by the author of a composite presentation. In this way, a user-author can provide some degree of control of the published content presentation, while still making the content presentation available to others. The permissions can also specify whether the content presentation may be used as a sub-presentation in combination with other sub-presentations authored by one or more specified users.

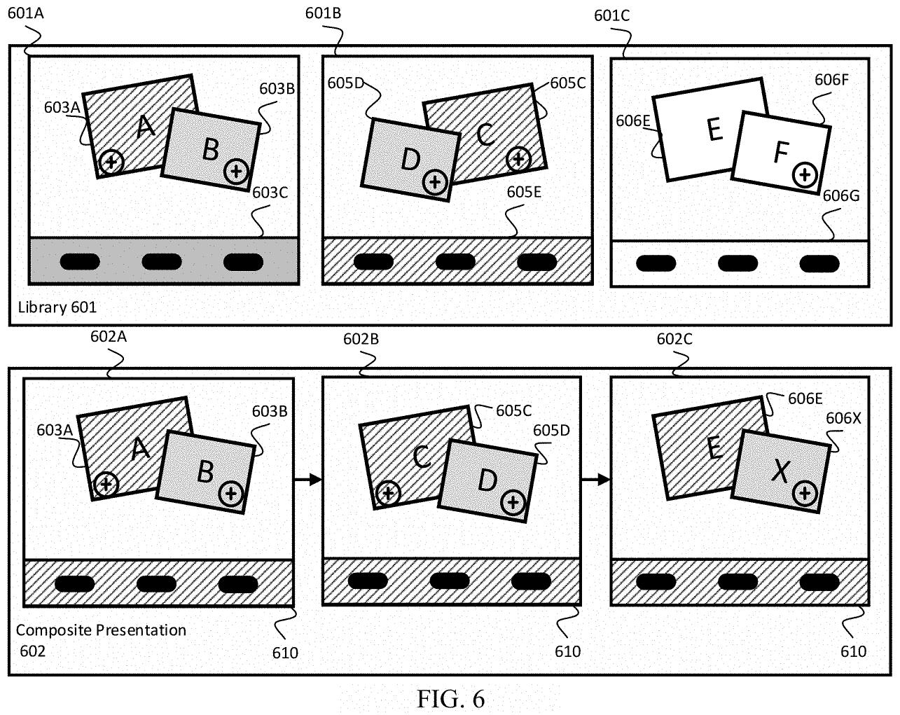

As also described herein with reference to FIGS. 5 and 6, the presentation permissions engine 120 can receive input corresponding to one or more display criteria for displaying a content presentation when added to a composite presentation as a sub-presentation. The display criteria can include restrictions on what, if any, content may be modified in the content presentation when presented as a sub-presentation, as well as restrictions for how the content is presented, including color schemes, arrangement of items of content relative to each other, and transitional effects or animations used between the sub-presentation and other sub-presentations and/or the primary presentation of the composite presentation.

The presentation display engine 130 is configured for retrieving one or more content presentations from the database 160, and displaying the content presentations for display, for example on a display of a requesting computing device. The display engine 130 can cause at least a portion of a content presentation to display on a display pane of a user interface. The user interface can include one or user-interactable elements for navigating through the content presentation. When the content presentation is a composite presentation, the display engine 130 can cause the composite presentation to be displayed with one or more presentation links provided in the composite presentation, for example during generation or modification of the content presentation.

A content presentation can define a sequential order of logical units within the content presentation, which can include, for example, slides or pages which separate content in one page or slide from content in another page or slide. A content presentation can include one or more slides, for example, which can be navigated or advanced back-and-forth beginning from an initial slide and ending in a terminal slide. The presentation display engine 130 can include a user interface for navigating back-and-forth between slides of the content presentation.

When a composite presentation includes a presentation link, the presentation display engine 130, in response to input received by the presentation link, such as a touch-press or mouse-click, can cause a slide linked in a sub-presentation to appear instead of the next slide in the sequential order of the content presentation without the presentation link. The presentation display engine 130 can, in response to user input at the presentation link, go to a particular slide or page of a destination content presentation. For example, input to the presentation link can cause the presentation display engine 130 to display the first slide of a sub-presentation, for example on a display device coupled to a user computing device. Thereafter, the presentation display engine 130 can navigate back-and-forth between slides of the linked sub-presentation. The linked sub-presentation can itself include one or more presentation links. The presentation display engine 130 can, in response to input to a presentation link of the previously linked sub-presentation, cause a slide or page of a second sub-presentation to be displayed, continuing the process.

In some examples, content presentations can loop indefinitely, for example because the terminal page or slide of a content presentation can link back to the initial page of the presentation. In other examples, the presentation display engine 130, in response to reaching the terminal page of a sub-presentation and input to advance the presentation further, can automatically display a page from another sub-presentation, continuing the sequence of slides or pages in the presentation. In yet other examples, a common display element such as a navigation bar can include one or more user-interactable elements for returning to a previous slide or sub-presentation, and/or another destination, such as an initial slide of the primary presentation. As described herein with reference to FIG. 4B, the use of presentation links allows the system to flexibly link the primary presentation and different sub-presentations in any variety of manners and arrangements.

The presentation display engine 130 can retrieve a locally or remotely stored sub-presentation, in response to input at a presentation link designating the sub-presentation as a destination. For example, the display engine 130 can, in response to input received at the link, determine whether the destination content presentation is currently in memory of the user computing device from which the input to the presentation link was received. If the presentation display engine 130 determines that the destination content presentation is present in memory, then the presentation display engine 130 can access the memory in which the destination content presentation is stored and cause the sub-presentation to be displayed on a display device coupled to the requesting computing device. If the destination content presentation is determined not to be in memory on the requesting computing device, the presentation display engine 130 can query the database 160 for the linked sub-presentation, and provide data related to the linked sub-presentation to the requesting computing device, including data for displaying at least a portion of the linked sub-presentation.

The presentation display engine 130 can also be configured to retrieve, for a composite presentation, the most up-to-date versions of the primary presentation and each sub-presentation in the composite presentation, prior to displaying the composite presentation. For example, the presentation display engine 130 can, in response to a request from a user computing device to display a composite presentation, determine that the user computing device has stored in memory the primary presentation and each of the sub-presentations in the composite presentation. The presentation display engine 130 can check versions of a sub-presentation stored on a requesting computing device, and in response to determining that the sub-presentation stored in memory on the computing device is not the most up-to-date version, download the version of the sub-presentation from the database 160. The presentation display engine 130 can then display at least a portion of the linked sub-presentation in response to input to the corresponding presentation link.

By checking and fetching up-to-date versions of linked sub-presentations, the system 100 can keep composite presentations up-to-date, even when changes are made to sub-presentations by their respective authors. Rather than saving a composite presentation as a static file in data, the system 100 can, for example in response to input or at least periodically, check that data defining a composite presentation stored on a user computing device is still up-to-date. When the system 100 does receive input to display a composite presentation, the system 100 can quickly check for any updates to linked sub-presentations, download any additional updates if necessary, and quickly present the composite presentation in response to the input.

In some examples, the system 100 can be configured to push updates to composite presentations linking a recently updated sub-presentation. Thereafter, even before the composite presentation is displayed, the user computing device for displaying the composite presentation is already up-to-date, even without the knowledge of the user of the device.

The presentation display engine 130 can be configured to display one or more common display elements that appear throughout different sub-presentations of a composite presentation. For example, and as shown and explained with reference to FIG. 4A, the common display elements can include a navigation bar or a common color scheme throughout the composite presentation. The presentation display engine 130 can retrieve one or more composite presentation display criteria previously received by the system 100, and add and modify common display elements of the composite presentation according to the received display criteria.

As described herein with reference to FIGS. 5-6, the system 100 can be configured to determine whether the composite presentation display criteria violate one or more permissions and/or sub-presentation display criteria corresponding to sub-presentations used to generate the composite presentation. For example, in addition to generating a content presentation using a common template, which a composite presentation author can be free to modify, the author of the content presentation can allow or not allow for other changes to be made to the content presentation, in addition to changes to common display elements of the template. A violation can occur when the system receives input for modifying a sub-presentation in a way that is prohibited by the display criteria for the sub-presentation. For example, if the display criteria for a sub-presentation prohibit the editing or rearranging of content on one or more slides of the sub-presentation, the system is configured to reject user input, for example from a user interacting with the system to generate a composite presentation, to modify the sub-presentation by editing or rearranging the content.

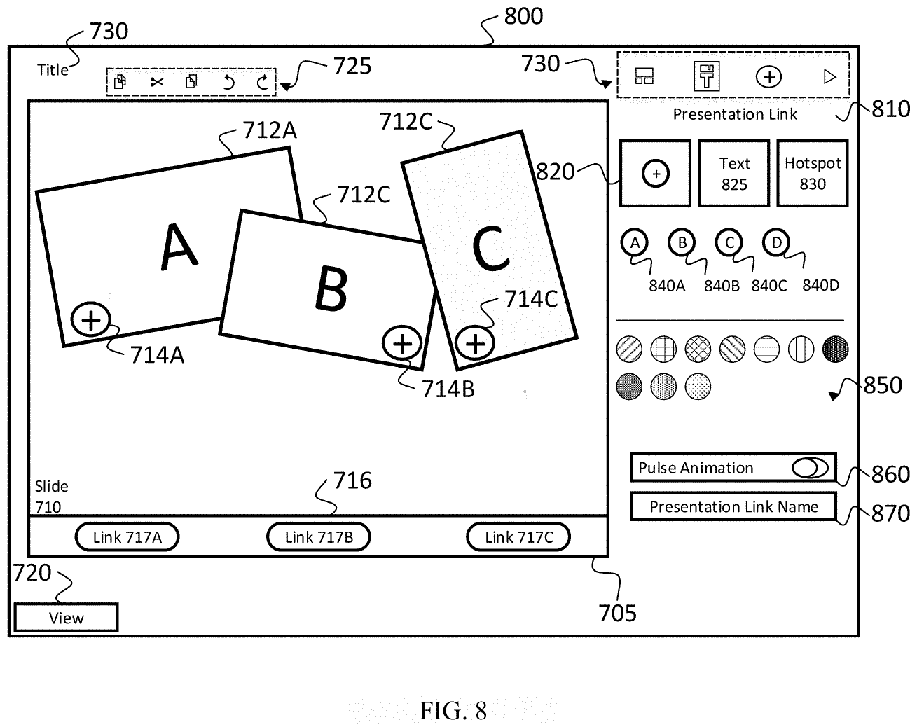

The presentation analytics engine 140 is configured to maintain data corresponding to metrics related to the use of content presentations across the system 100 in various different composite presentations. For example, for a given content presentation, e.g., a composite presentation, a primary presentation, a sub-presentation to a composite presentation, or a content presentation neither part of a composite presentation nor including sub-presentations of its own, the presentation analytics engine 140 can track the number of times the content presentation was a response to a download request to the system 100. As another example, the presentation analytics engine 140 can track the number of times the content presentation was included as a sub-presentation in a composite presentation by other users of the system 100. The presentation analytics engine 140 can also be configured to track, for presentation links within a composite presentation, how many times a particular presentation link was accessed. As described herein with reference to FIGS. 7-8, slides of a content presentation and/or presentation links within a composite presentation can be provided names for tracking analytics data specific to those slides and/or presentation links.

The presentation analytics engine 140 can provide, in response to a request for data, analytics data, including data for one or more content presentations and/or presentation links within the one or more content presentations. The presentation analytics engine 140 can receive and maintain one or more analytics permissions corresponding to each user of the system 100. Analytics permissions can specify whether analytics data for content presentations authored by a user are available to other users, or private to a specified subset of users. The presentation analytics engine 140 can also be configured to only track analytics data for one or more content presentations in response to affirmative input from one or more authoring users of the content presentations, e.g., user input received in response to a prompt to allow analytics data to be tracked by the system 100.

The presentation analytics engine 140 can generate, as output, the analytics data in response to a request, for example from a user computing device logged into a user account with appropriate permissions to view the analytics data. The analytics engine 140 can display raw data for one or more metrics tracked, as described herein. The analytics engine 140 can also be configured to process the tracked metrics and provide one or more graphs, charts, or other visual representations of the tracked metrics, for example per-presentation, per-slide or page, per-presentation link, or over a specified period of time. The analytics engine 140 can also be configured to track user interactions with any of a variety of user-interactable elements, such as buttons available as part of a content presentation. Information relating to these interactions can also be represented as one or more tracked metrics and visualized on a display and/or generated as part of an analytics report provided by the analytics engine 140.

As an example use case, users of the system 100 can include users involved in the construction business, or any other industry that involves presenting bids for projects from a client. For example, the system 100 can receive input from a first user to generate a composite presentation for presenting a bid to build a house or some other type of building. The composite presentation can include a primary presentation authored by the user, which can include content, for example, related to general logistics, costs, and/or a timeline for executing the construction project.

Sub-presentations can be provided by various sub-contractors or vendors providing products or services related to more-specific aspects of the project. For example, one sub-presentation can relate to details for the exterior of a building being constructed, another sub-presentation related to the plumbing for the building, and yet another sub-presentation related to interior decoration for the building once constructed. Aspects of the disclosure as described herein allow individual entities, like sub-contractors, to prepare presentations related to their service, while also making their presentations available for the general contractor to use in their composite presentation. At the same time, sub-contractors or vendors, as independent entities, may also wish to protect content and presentation of their content related to their service or products, and not allow unfettered control to a general contractor who may not have a relation with the sub-contractor or vendors beyond a bid for the example construction project.

Aspects of the disclosure also provide for managing sub-presentations when included in composite presentations, ensuring that a sub-presentation is used as intended by its respective author, and also is provided up-to-date automatically when distributed across different composite presentations.

FIG. 2 is a block diagram of an example computing environment 200 in which the example content presentation system 100 can be implemented, according to aspects of the disclosure. The system 100 can be implemented on one or more devices having one or more processors in one or more locations, such as in server computing device 215.

User computing device 212 and the server computing device 215 can be communicatively coupled to one or more storage devices 230 over a network 260, which can include the database 160. The storage device(s) 230 can be a combination of volatile and non-volatile memory, and can be at the same or different physical locations than the computing devices 212, 215. For example, the storage device(s) 230 can include any type of non-transitory computer readable medium capable of storing information, such as a hard-drive, solid state drive, SD card, optical storage, memory card, ROM, RAM, DVD, CD-ROM, write-capable, and read-only memories.

The server computing device 215 can include one or more processors 213 and memory 214. The memory 214 can store information accessible by the processor(s) 213, including instructions 221 that can be executed by the processor(s) 213. The memory 214 can also include data 223 that can be retrieved, manipulated or stored by the processor(s) 213. The memory 214 can be a type of non-transitory computer readable medium capable of storing information accessible by the processor(s) 213, such as volatile and non-volatile memory. The processor(s) 213 can include one or more central processing units (CPUs), graphic processing units (GPUs), field-programmable gate arrays (FPGAs), and/or application-specific integrated circuits (ASICs).

The instructions 221 can include one or more instructions that when executed by the processor(s) 213, causes the one or more processors to perform actions defined by the instructions. The instructions 221 can be stored in object code format for direct processing by the processor(s) 213, or in other formats including interpretable scripts or collections of independent source code modules that are interpreted on demand or compiled in advance. The instructions 221 can include instructions for implementing the content presentation system 100 consistent with aspects of this disclosure. The content presentation system 100 can be executed using the processor(s) 213, and/or using other processors remotely located from the server computing device 215.

The data 223 can be retrieved, stored, or modified by the processor(s) 213 in accordance with the instructions 221. The data 223 can be stored in computer registers, in a relational or non-relational database as a table having a plurality of different fields and records, or as JSON, YAML, proto, or XML documents. The data 223 can also be formatted in a computer-readable format such as, but not limited to, binary values, ASCII or Unicode. Moreover, the data 223 can include information sufficient to identify relevant information, such as numbers, descriptive text, proprietary codes, pointers, references to data stored in other memories, including other network locations, or information that is used by a function to calculate relevant data.

The user computing device 212 can also be configured similar to the server computing device 215, with one or more processors 216, memory 217, instructions 218, and data 219. The user computing device 212 can also include a user output 226, and a user input 224. The user input 224 can include any appropriate mechanism or technique for receiving input from a user, such as keyboard, mouse, mechanical actuators, soft actuators, touchscreens, microphones, and sensors.

The server computing device 215 can be configured to transmit data to the user computing device 212, and the user computing device 212 can be configured to display at least a portion of the received data on a display implemented as part of the user output 226. The data transmitted can include, for example, data for displaying a content presentation. The user output 226 can also be used for displaying an interface between the user computing device 212 and the server computing device 215, for example as described herein with reference to FIGS. 7-10B. The user output 226 can alternatively or additionally include one or more speakers, transducers or other audio outputs, a haptic interface or other tactile feedback that provides non-visual and non-audible information to the user of the user computing device 212.

Although FIG. 2 illustrates the processors 213, 216 and the memories 214, 217 as being within the computing devices 215, 212, components described in this specification, including the processors 213, 216 and the memories 214, 217 can include multiple processors and memories that can operate in different physical locations and not within the same computing device. For example, some of the instructions 221, 218 and the data 223, 219 can be stored on a removable SD card and others within a read-only computer chip. Some or all of the instructions and data can be stored in a location physically remote from, yet still accessible by, the processors 213, 216. Similarly, the processors 213, 216 can include a collection of processors that can perform concurrent and/or sequential operation.

The server computing device 215 can be configured to receive data for generating, modifying, and publishing content presentations and composite presentations from the user computing device 212. For example, the environment 200 can be part of a computing platform configured to provide a variety of services to users for content presentation generation, management, and display, through various user interfaces and/or Application Programming Interfaces (APIs) exposing the platform services.

The server computing device 215 can be configured to receive data for managing and updating a user account corresponding to a user of the system 100. This data can include, for example, content presentations authored or co-authored by the user, content included in an authored content presentation, such as text, images, video, or sound clips, and input for managing the user account corresponding to the user. The latter input for managing the user account can include updating a library of content presentations for a user, as well as managing which groups the user belongs to. The server computing device 215 can be configured to receive data for managing permissions and display criteria for composite presentations authored by the user, as well as permissions and display criteria for content presentations published to the system 100 authored by the user.

The devices 212, 215 can be capable of direct and indirect communication over the network 260. The devices 215, 212 can set up listening sockets that may accept an initiating connection for sending and receiving information. The network 260 itself can include various configurations and protocols including the Internet, World Wide Web, intranets, virtual private networks, wide area networks, local networks, and private networks using communication protocols proprietary to one or more companies. The network 260 can support a variety of short- and long-range connections. The short- and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTE® standard for wireless broadband communication. The network 260, in addition or alternatively, can also support wired connections between the devices 212, 215, including over various types of Ethernet connection.

Although a single server computing device 215 and user computing device 212 are shown in FIG. 2, it should be understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

In some examples, at least portions of the content presentation system 100 are implemented on the server computing device 215, and at least portions of the content presentation system 100 are implemented on the user computing device 212. For example, the user computing device 212 can include a combination of hardware, firmware, and/or software configured to generate, modify, and display content presentations as described herein. The user computing device 212 can also be configured to store one or more content presentations in memory, which can be for example from a library generated through user input to the device 212, or content presentations at least partially authored by a user of the computing device 212.

The user computing device 212 can at least partially implement the user interface as described herein, for example with reference to FIGS. 7-10B, and be configured to present content presentations for display on a display device communicatively coupled to the user computing device 212. The user computing device 212, as part of accessing a content presentation, can determine whether the most recent version of the presentation is currently stored in the memory 214. If not, the user computing device 212 can send a request to the server computing 215 to provide the most up-to-date version of a content presentation, including any sub-presentations if the content presentation is a composite presentation.

### Example Methods

FIG. 3 is a flowchart of an example process 300 for generating and displaying a composite presentation. A content presentation system including one or more processors, such as the content presentation system 100 of FIGS. 1-2, can perform the process 300.

The system receives a primary presentation and one or more sub-presentations, according to block 310. The system can receive the primary presentation and the one or more sub-presentations based on user input specifying one or more content presentations stored in the database for the system. The system can receive the primary presentation and the one or more sub-presentations at once, or sequentially. For example, the system can receive the primary presentation. After receiving the primary presentation, and optionally receiving input for modifying the content presentation, the system can receive data specifying a first sub-presentation to add to the first content presentation, creating at least a partial composite presentation. After optionally receiving input that causes the system to modify the first sub-presentation, the system can receive a second sub-presentation, linked to one or both of the primary presentation and the first sub-presentation as described herein. As also described herein with reference to FIG. 5, the system can determine whether a user authoring the composite presentation to be generated as sufficient permissions to generate the composite presentation using the one or more sub-presentations, and the primary presentation, if the user is not the author of the primary presentation.

The system links the primary presentation to at least one of the one or more sub-presentations, according to block 320. As described herein with reference to FIGS. 1, 4A-B, and 8, the composite presentation can include one or more presentation links. The system can provide an interface, for example as described herein with reference to FIG. 7, for creating and modifying a content presentation. As also described herein with reference to FIG. 8, the system can provide a user interface for adding and modifying presentation links to the primary presentation and/or sub-presentations of the composite presentation.

The system generates data for displaying the composite presentation with one or more display elements in common across the primary presentation and each of the one or more sub-presentations, according to block 330. The data for displaying the composite presentation can include the content from each presentation, as well as metadata specifying how the content is to appear on each slide or page of the composite presentation. The one or more display elements can be, for example, from a common template applied during the creation of the individual primary presentation and the one or more sub-presentations. The data for displaying the composite presentation can vary based on modifications received as input for modifying the composite presentation, for example through user interfaces 700-800 described herein with reference to FIG. 7-8.

In some embodiments, the system generates data for displaying the composite presentation according to one or more composite presentation display criteria. The composite presentation display criteria can include individual modifications received separately by the system, for example individual inputs to change the shape or size of a content item in the composite presentation. In other examples, the system receives input specifying display criteria for making changes across the entire composite presentation, e.g., input for changing the font type across the entire composite presentation, including all sub-presentations.

At least some of the modifications can be made to the composite presentation based on user input specifying criteria for how common display elements across the sub-presentations are to be displayed. These common display elements can be at least part of a common template used or added to each sub-presentation. For example, the received sub-presentations can be sub-presentations previously generated using the same or similar template, and have some common display elements from sub-presentation to sub-presentation. Templates may be called similar if they share at least one common element among each other, e.g., two templates are similar if the templates have at least a navigation bar between each other.

The system can provide a number of templates for creating a content presentation. In some examples, users of the system can publish their own templates for use in content presentation that can include presentations authored by users different from the publishing users. The system facilitates the use of templates, for example by maintaining a repository of templates that can be searched in response to user queries. In addition, the use of templates as described herein provides a way for a system to generate a composite presentation which, from the perspective of an audience, does not appear to have been the effort of separate, potentially unrelated, users. The use of templates as described here also provide a separation between elements of a content presentation that an author can allow for modification according to display criteria for a composite presentation featuring the content presentation, and elements that are unique to the sub-presentation and that are not allowed to be changed, as described herein through sub-presentation display criteria and FIG. 5. As part of generating the composite presentation, the system can modify common display elements in templates across each sub-presentation, for example by changing the color or design scheme according to user input received from the author of the composite presentation.

In some examples, if a received sub-presentation does not use the same or similar template as other received sub-presentations, the system can modify the received sub-presentation to include the same or similar template, and modify the template according to modifications specified by the composite presentation display criteria as described herein.

In this way, each presentation can define its own theme through the use of different templates, for example through colors, fonts, and visual styling and presentation of various display elements, such as a navigation bar. While a presenter navigates from one presentation to another, the display elements change in color and/or in style according to the themes defined by the various templates used by the presentations, providing for a seamless transition.

The system displays at least a portion of the composite presentation, according to block 340. The system can provide a user interface for displaying a composite presentation, which can include a display pane for viewing one or more pages or slides of a composite presentation. The user interface can include user-interactable elements for advancing back-and-forth between slides or pages according to a sequence specified as part of generating the content presentation. For a slide or page displayed through the user interface, the user interface through a display pane can also display one or more presentation links. Each link, in response to user input, can cause the system to display at least a portion of a destination content presentation specified during creation of the presentation link, for example as described herein with reference to FIG. 8.

FIG. 4A is a diagram of an example slide 400A from a composite presentation, according to aspects of the disclosure. The slide 400A can include content items 401A-401B, which in this example are arranged with a partial overlap of the content item 401B over the content item 401A. Content item 401C is also shown spanning the width of the slide 400A. It is understood that in different examples, a slide of a composite presentation can include different types of content, arranged in any of a variety of different ways.

The content items 401A-B include presentation links 402A-B, respectively. The presentation links 402A-B are shown as graphical icons, e.g., as circles with “+” signs in the middle. As described herein with reference to FIG. 8, presentation links can be added according to a variety of different styles, including as icons, text, or as hotspots configured to receive user input. The order and position of the presentation links 402A-B can vary in response to user input. In this example, the position of the presentation link 402A suggests that the destination content presentation for the presentation link 402A may be related to the content item 401A. The content item 401A can, for example, include a summary of the contents of a sub-presentation linked by the presentation link 402A. Similarly, the presentation link 402B may be linked to a sub-presentation related to the content item 401B. The relationship between presentation links and content items is exemplary, and the system is configured to receive input for positioning and ordering content and presentation links of the slide 400A in any manner.

The slide 400A also includes a navigation bar 403 with presentation links 403A-C. The navigation bar 403 is shaded to match the content item 401A, which can be the result of received input by the system for modifications specified by composite presentation display criteria. As an example, the system can cause the color of the navigation bar 403 to appear a certain color to match a dominant color scheme for the slide 400A. The system can be configured to automatically determine the dominant color scheme, for example by comparing different colors in a slide and determining which color appears most often, or the system can receive the dominant color scheme as user input. The system can apply these criteria across different sub-presentations in a composite presentation. For example, if the color scheme for the destination content presentation of the presentation link 402B was white, then the system can cause the navigation bar to appear white when the destination content presentation is displayed.

In some examples, the navigation bar can include one or more internal links to slides within the same sub-presentation, in addition to presentation links for moving from one sub-presentation to a destination content presentation, as described herein.

FIG. 4B is a block diagram of a composite presentation 450, according to aspects of the disclosure. The composite presentation includes content presentations 400-425, indicated by dashed boxes surrounding respective slides for each presentation. A content presentation 400 includes slide 400A, which includes presentation links 402A-B, 403A-C, as described herein with reference to FIG. 4A. In this example, the content presentation 400 can be a primary presentation, from which sub-presentations 405-425 can be reached directly or indirectly using one or more presentation links. From the slide 400A, the system can advance the primary presentation 400 to slide 400B, according to a sequence of slides specified when the primary presentation 400 was generated. Similarly, from slide 400B, the system can advance to slide 400C, for example in response to user input.

In this example, the slide 400C is the terminal slide of the primary presentation 400, and when the system receives input to advance in the composite presentation 450, the next slide display is slide 410A from the sub-presentation 410. This example shows that the primary presentation 400 can transition to another sub-presentation as part of advancing normally through the composite presentation and without receiving input at a presentation link.

Several arrows are shown in FIG. 4B starting from a presentation link in the slide 400A, and ending at a slide at a respective destination content presentation. For example, in response to receiving input from the presentation link 402A, the system can advance to the slide 410A of the sub-presentation 410. From the presentation link 403A, the system can advance to the sub-presentation 425, which includes slides 425A, B. The sub-presentation 425 can advance to the sub-presentation 420, which includes slides 420A, B. The sub-presentation 420 can advance to the slide 410B of the sub-presentation 410. Note that presentation link 403B can also cause the system to advance to slide 420A of the sub-presentation 420.

The presentation link 403C can cause the system to advance to slide 415A of sub-presentation 415, which also includes slides 415B, C. From slide 415C, the system can advance in two directions, either to sub-presentation 410 or sub-presentation 420. In this example, the slide 415C may have one or more presentation links, as shown in the slide 400A. In general, the primary presentation and each sub-presentation of the composite presentation 450 may include a respective number of presentation links, and the system is configured to handle arbitrary configurations of sub-presentations each having an arbitrary number of presentation links to other sub-presentations. For example, the presentation links 403A-C, as part of a navigation bar appearing across each presentation 400-425, allow for linking to the destination content presentations of the presentation links 403A-C from any other content presentation in the composite presentation 450. The arrow linking between each sub-presentation has not been shown, for ease of description, although it is understood that a respective navigation bar can include the presentation links 403A-C accessible at each presentation 400-425.

The presentation link 402B also causes the system to advance to the sub-presentation 415, as with the presentation link 403C. However, the presentation link 402B can receive input that causes the system to advance to slide 415B of the sub-presentation 415, instead of the slide 415A as with the presentation link 403C. This example shows that different presentation links may link to the same sub-presentation, but at different slides within the sub-presentation.

The composite presentation 450 is shown as ending at slide 410B. In some examples, the slide 410B can include presentation links, for example at the presentation links 403A-B. In other examples, the slide 410B can represent a natural end of the composite presentation, and the system is configured to close the composite presentation 450. In other examples, advancing the composite presentation 450 from the slide 410B causes the system to loop back to an initial slide of the presentation, in this example the slide 400A.

A navigation bar or other common element across the composite presentation 450 can include a user-interactable element for returning to a previous slide or content presentation, or back to the initial slide of the composite presentation 450, here the slide 400A of the primary presentation 400.

As described herein, the system is configured to retrieve up-to-date versions of each content presentation 400-425 in the composite presentation 450. In some examples, the system retrieves all of the content presentations 400-425 and stores them in memory at a device configured to display the composite presentation 450. In other examples, the system can retrieve the sub-presentations in real-time, meaning that the system can retrieve sub-presentations only in response to receiving input at a presentation link in which a sub-presentation is specified as a destination. The system can also periodically check for updates to composite presentations already stored in memory on a user computing device.

FIG. 5 is a flowchart of an example process 500 for modifying a composite presentation according to sub-presentation display criteria and permissions, according to aspects of the disclosure. A content presentation system including one or more processors, such as the content presentation system 100 of FIGS. 1-2, can perform the process 500. For example, the system can perform the process 500 in response to receiving input to add a sub-presentation to a composite presentation, for example as described herein with reference to FIGS. 3-4B.

The system receives an up-to-date version of the sub-presentation and proposed modifications to the sub-presentation, according to block 510.

The system receives display criteria and/or permissions for a sub-presentation, according to block 520. The display criteria as described herein with reference to FIGS. 1-3 can include conditions allowing or not allowing certain modifications to be done to the sub-presentation when added as part of a composite presentation. For example, these criteria can include not modifying content of the sub-presentation, not rearranging content on one or more slides or pages of the sub-presentation, not editing certain pages or slides altogether, or only using certain versions of the sub-presentation in a composite presentation. The permissions as also described herein can specify which users are and are not permitted to generate a composite presentation including the sub-presentation. In some examples, a sub-presentation may be available for inspection by a set of users, but may only be used in generating a composite presentation by another set of users. In yet other examples, the permissions include permissions for both viewing and using a content presentation as a sub-presentation in a composite presentation.

The system determines whether there is permission to use the sub-presentation in the composite presentation, according to block 530. To make the determination, the system can compare permissions for the sub-presentation with the user corresponding to a request to add the sub-presentation to a composite presentation. If the permissions do not include the user, or specifically exclude the user, then the system determines that there are insufficient permissions (“NO”) and the process 500 ends. If the process 500 ends because of insufficient permissions, the system can be configured to output for display a prompt indicating the reason why the sub-presentation could not be added to the composite presentation.

If the system determines that there is sufficient permission to use the sub-presentation (“YES”), the system determines whether modification in the sub-presentation violates sub-presentation display criteria, according to block 540. The system is configured to receive input for modifying a content presentation, as described herein with reference to FIG. 1 and FIGS. 7-8. When the system receives input to modify a content presentation from a computing device corresponding to the user account for the author, the system can make the indicated modifications according to the input. As described herein with reference to FIG. 3, some input modifications can include modifications specified from composite presentation display criteria. For the sub-presentation in the example in which the user of the composite presentation is not also the author of the sub-presentation, the system determines whether the proposed modifications violate conditions specified by the sub-presentation display criteria.

If the proposed modifications violate the sub-presentation display criteria (“YES”), then the process 500 ends, and the system can provide a prompt for display explaining why the modifications were unsuccessful, e.g., because the author of the sub-presentation has prohibited the modification as specified by the sub-presentation display criteria.

If at least one of the proposed modifications does not violate the sub-presentation display criteria (“NO”), then the system displays at least a portion of the composite presentation with the allowed modifications, according to block 550. In some examples, some modifications may be successfully made, while others are not for violating the sub-presentation display criteria.

At least through the process 500, the system can balance control over presentations between authors of sub-presentations and authors of composite presentations. The system provides for using published content presentations in other presentations, which can be beneficial for increasing exposure of content in the published content presentations. At the same time, freely publishing a content presentation makes it difficult to maintain autonomy of how the presentation is used, which can be particularly important because the name and goodwill of the author is attached to the presentation. An author of a composite presentation, even when selecting from different sub-presentations with the same or similar template, may wish to make modifications in the format across the entire composite presentation, so as to generate a product that to an audience appears to have been from the same source, as opposed to potentially unrelated authors. The resulting presentation can appear more organized and coherent, at least because common display elements tie sub-presentations together. The composite presentation author is free to make modifications subject to the conditions imposed by sub-presentation authors, who may balance the control they maintain over their presentations with still making the presentation accessible for others to use.

FIG. 6 illustrates example modifications of sub-presentations 601A-C from a user library 601 to a composite presentation 602, according to aspects of the disclosure. In FIG. 6, each presentation 601A-C, 602A-C uses a common template that includes a navigation bar.

Presentation 601A includes content item 603A, content item 603B, and navigation bar 603C. In this example, the composite presentation 602 includes presentation 602A, representing a modified version of the presentation 601A. In the composite presentation 602A, the only modification made to the presentation 602A is to add hatching marks to navigation bar 610, a common element across the composite presentation 602. The presentations 601A and 602A are unchanged, to show, for example, that the system did not receive additional modifications for modifying the presentation 601A, or because modifications that were received were not implemented for violating sub-presentation display criteria for the presentation 601A.

Presentation 601B includes content items 605D, 605C, and navigation bar 605E. In this example, the composite presentation 602 includes presentation 602B, representing a modified version of the presentation 601B. Specifically, the position of content items 605C, D, are flipped. In addition, as with the presentation 602A, the navigation bar 610 is hatched, which is unchanged from the navigation bar 605E. The changes between presentations 601B, 602B can show, for example, that sub-presentation display criteria for the presentation 601B permitted the rearrangement of the content items 605C, 605D from user input of the composite presentation author, but may not have allowed for edits to the content itself, or changes in the color scheme of the content items 605C, 605D.

Presentation 601C includes content items 606E, 606F, and navigation bar 606G. In this example, the composite presentation includes presentation 602C, representing a modified version of the presentation 601C. Specifically, the design of the content item 606E has been changed from plain to a hatched pattern, and the content item 606F has been replaced by a content item 606X. In addition, as with the presentations 601A, B, the navigation bar 606G has been replaced with the hatched navigation bar 610. The changes between presentations 601C, 602C can show, for example, that the sub-presentation display criteria for the presentation 601C permit not only change to display elements of the presentation 601C, but also changes to the content itself, as shown by the change from the content item 606F to the content item 606X. As another possible explanation for the modifications between the presentations 601C, 602C, the author of the composite presentation 602 may be the same user who is the author of the content presentation 601C, in which case the user would have full permission in making changes to their own presentation.

Although in FIG. 6 the navigation bar 610 is shown in a hatching pattern across the presentations 602A-C, as described herein the navigation bar 610 and other common elements of a template can be modified on a per-sub-presentation basis, for example changing in color to matching a dominant color theme across each sub-presentation. The creation of the presentations 601A-C using a common template, which in this example included a navigation bar, helped to facilitate a seamless presentation of the composite presentation 602, at least because common display elements were available for modification by the user-author of the presentation 602. In addition, FIG. 6 also illustrated examples for other modifications that may or may not be permitted in each of the presentations 601A-C, in addition to modifying common display elements.

### Example User Interfaces

FIGS. 7-10B show example user interfaces for interaction between the content presentation system as described herein, and a user of the system. User-interactable elements can be implemented in any one of a number of different ways, for example as buttons, toggles, switches, or other types of user interface elements for receiving user input.

The user interfaces described with reference to FIGS. 7-10B and throughout this disclosure are exemplary, and it is understood that in some implementations, the system can include user interfaces with more or fewer elements that what is described presently, and/or with the same elements arranged differently that what is described with reference to FIGS. 7-10B.

FIG. 7 shows an example user interface 700 for modifying a composite presentation, according to aspects of the disclosure. The user interface 700 can include a display preview 705 showing a slide 710 from a content presentation. The slide 710 can include content items 712A-C, with corresponding presentation links 714A-C. The slide 710 can also include a navigation bar 716 with navigation bar links 717A-C. The user interface 700 can include a title 731 indicating the title of the presentation currently being modified. The user interface 700 can include a user-interactable element 720 for viewing the presentation, for example as described herein with reference to FIG. 4A.

The user interface 700 can include alteration user-interactable elements 725 which can be generally configured for receiving input for saving the presentation, cutting, copying, and pasting content items of the presentation, and undoing or redoing actions taken to the slide 710, for example actions to modify content or the format of content on the slide 710. If the slide 710 is part of a sub-presentation with sub-presentation display criteria, the user interface 700 can be configured to prompt the user in response to receiving input to modify the slide 710 in violation of the criteria, as described herein with reference to FIG. 5. In some examples, certain elements of the slide 710 can be greyed out or be unable to receive user input, for example to indicate that the author of the sub-presentation has prohibited certain changes to the presentation.

The user interface 700 can include navigation user-interactable elements 730 for navigating to different menus of the user interface 700. For example, as shown by header 740, user interface 700 is set to show a menu for changing slide or page settings of the slide 710. The slide/page settings can include a slide name user-interactable element 750 for modifying the name of the slide 710. Adding a name to the slide 710 can have several advantages. In addition to aiding in the organization of the content presentation in general, adding a name to the slide 710 can provide a reference for tracking analytics data related to the slide 710. For example as described herein with reference to FIG. 1, the system can track analytics data related to different metrics. The system can aggregate and present metrics corresponding to the specific slide 710, designating it by name in an analytics report. The system can also receive input to filter out analytics data, for example, by specific named pages or presentation links.

The user interface 700 also includes a slide/page lock user-interactable element 760 for toggling whether the slide 710 (or the currently displayed slide) is locked from editing or not. In response to input from the slide/page lock user-interactable element 760, the system can lock the slide 710 from editing from all users (including the author of the presentation, until the slide is later unlocked). The state of the slide 710 can be represented in sub-presentation display criteria when or if the presentation being modified is used as a sub-presentation in a composite presentation. The system can prevent any modifications to the slide 710 by other users in their own composite presentations, at least until the slide/page lock user-interactable element 760 receives input to disable the lock.

The user interface 700 can include a slide/page advancing user-interactable element 770 for adjusting how slides in the presentation are progressed through. As described herein with reference to FIGS. 1, 3, and 4, content presentations can include a sequence of slides or pages, beginning from an initial slide and ending in a terminal slide. The slide/page advancing user-interactable element 770 can receive input which can cause the content presentation system to change the type of input necessary to advance the presentation forward or backward. For example, the system can configure the presentation to react to swipe input (e.g., through a finger gesture across a touchscreen), mouse click or finger tap, or to automatically advance, e.g., after a predetermined period of time. In the user interface 700, the slide/page advancing user-interactable element 770 includes an option for “swiping normal,” although other options can include different types of inputs for advancing the presentation, as well as how fast or how slowly the transition occurs between slides of the presentation.

The user interface 700 can include a slide/page background user-interactable element 780 for adjusting the format and presentation of the background of the slide 710. The slide/page background user-interactable element 780 can include a number of options for changing the background, for example according to different types which can be toggled with a type user-interactable element 790. In the user interface 700, the type user-interactable element 790 includes types for “solid,” “gradient,” and “image” backgrounds. Different backgrounds can also be provided through user input, for example receiving from a user computing device and made available by the system for modifying slides or whole content presentations.

The user interface 700 can include a templates user-interactable element 790, which in response to user input, causes the user interface 700 to provide one or more templates for applying to the content presentation currently being modified. As described herein, templates can include navigation bars, or other common display elements which can be applied to each slide or page of a content presentation. Other examples of common display elements can include graphics, logos, or persistent text elements provided on each slide or page of the content presentation.

FIG. 8 shows an example user interface 800 for adding a presentation link to a composite presentation, according to aspects of the disclosure. The example user interface 800 is similar to the user interface 700 includes elements 810-870 for adding and modifying presentation links, described presently.

The user interface 800 includes a header 810 for “Presentation Link,” indicating that at least some of the user-interactable elements on the user interface 800 relate to adding, modifying, or removing presentation links from the slide 710. A presentation link can be represented in a number of different ways, for example as an icon, text, or a hotspot. An icon presentation link user-interactable element 820 can receive input for adding a presentation link to the slide 710 in the form of an icon. In slide 710, the presentation links 714A-D are shown as icons.

A text presentation link user-interactable element 825 can receive input for adding a presentation link as text to the slide 710. The user interface 800, in response to receiving input from the user-interactable element 825, can prompt the user for text to add as the presentation link.

A hotspot presentation link user-interactable element 830 can receive input for designating at least a portion of the slide 710 as a presentation link. For example, in response to receiving input at the user-interactable element 830, the system can prompt the user to specify, through additional input, a region of the slide 710. For example, the additional input can be a bounding box dragged across a portion of the slide 710. The system can then cause the region specified by the additional input to link to a destination content presentation in response to user input.

Whether the presentation link is an icon, text, or a hotspot, the user interface 800 is configured to receive input, for example a mouse click or a touchscreen press, at a location in the slide 710 intended for adding the presentation link. The user interface 800 can also prompt the user for the destination content presentation of the presentation link. For example, the user interface 800 can display one or more of user interfaces 900, 1000A, 1000B, as described herein with reference to FIGS. 900-1000B. From the displayed interface, the system can receive user input specifying a destination content presentation.

Presentation link type user-interactable elements 840A-D can each correspond to a different type of presentation link icon type, for example different icons or graphics when the added presentation link is an icon, or different styles of text when the added presentation link is text. The user interface 800 can include a number of preset icons or text styles, and/or receive additional icon or text styles as user input.

The user interface 800 can also include one or more presentation link background user-interactable elements 850. The user-interactable element 850 can each correspond to a different type of background that the presentation link can have, for example any one of a number of different colors, gradients, patterns or images.

The user interface 800 can include a pulse animation user-interactable element 860. In response to input at the user-interactable element 860, the user interface 800 can cause a selected presentation link to pulse or remain static. Pulsing the presentation link can provide a visual indication that the link is interactable, for example. In other examples, other options for animating the presentation link are made available by the user interface 800. Other types of example animations include shaking, rotating, or blinking, although any type of animation can be implemented in different examples.

The user interface 800 can include a presentation link user-interactable element 870. The user-interactable element 870 can receive input for specifying a name for a selected or added presentation link. As described herein with reference to FIG. 7 and the slide name user-interactable element 750, adding a name to the presentation link can be used for tracking analytics data unique to the named presentation link, such as the number of times the link was accessed.

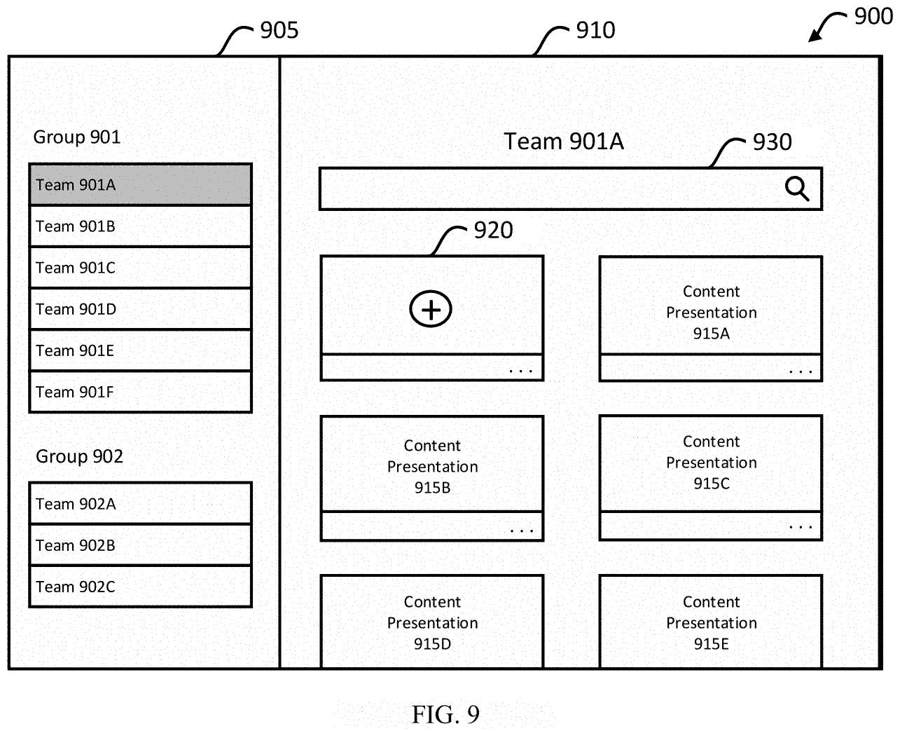

FIG. 9 shows an example user interface 900 for viewing and searching a library of sub-presentations maintained by the system, according to aspects of the disclosure. A library can include a subset of content presentations available on the system 100, curated through user input by one or more users accessing the library. For example, the system 100 receives input for generating a library of content presentations related to one or more composite presentations the user is creating using the system 100. Returning to the example of contractors and sub-contractors described herein, an example user can be a contractor with a library of content presentations corresponding to different sub-contractors whose presentations they wish to use in their own composite presentations for presenting contract bids.

The user interface 900 includes a panel 905. The panel 905 shows a group 901 including user-interactable elements corresponding to teams 901A-F, and group 902 including user-interactable elements corresponding to teams 902A-C. Each team can include one or more users. As shown in panel 910, team 901A is currently selected, and thumbnails for content presentations 915A-E are displayed corresponding to presentations shared with the team 901A. From the panel 905, the system can receive input at the thumbnails for the content presentations 915A-E, and cause the computing device from which the input was received for presenting the corresponding content presentation, for example as shown in reference to slide 400A of FIG. 4A.

The panel 910 can also include a user-interactable element 920 for generating a new presentation, which for example can appear when a team is accessing their own content presentations. The system can be configured to, in response to receiving input at the user-interactable element 920, cause the user interface to update to an interface for generating a new content presentation, for example user interfaces 700, 800 of FIGS. 7, 8. The panel 910 also includes a search bar 930 for searching through the content presentations 915A-E (and other content presentations shared with the team 901A not currently in view of the user interface 900). The system can be configured to tag each content presentation, for example by name, date of creation, date of modification, type of content in the presentation itself, etc.

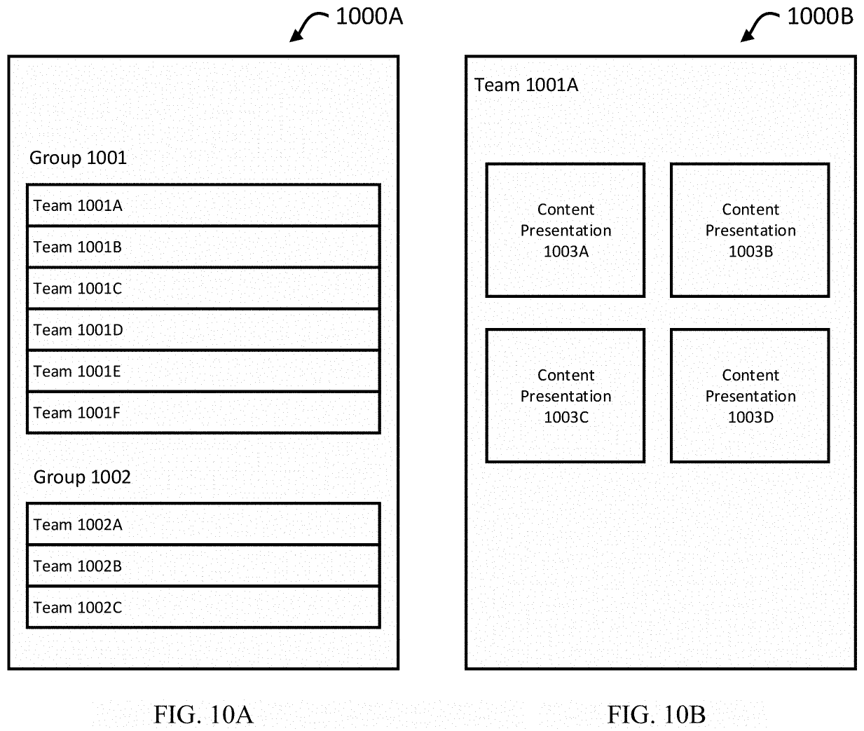

FIGS. 10A-B show example user interfaces 1000A-B. User interfaces 1000A and 1000B can be accessed through one or more user-interactable elements of other user interfaces, for example through one or more buttons or user-interactable elements on user interfaces as shown in FIGS. 7-9. For example, in response to input, the system 100 can overlay the user interfaces 1000A-B over the currently displayed interface, such as the interface 700 of FIG. 7.

FIG. 10A shows an example user interface 1000A for viewing content presentations shared with teams on the system, according to aspects of the disclosure. The user interface 1000A shows group 1001 and group 1002. Group 1001 includes user-interactable elements corresponding to teams 1001A-F, and group 1002 includes user-interactable elements corresponding to teams 1002A-C. Each team can include one or more users.

FIG. 10B shows an example user interface for viewing presentations of a team 1001A, according to aspects of the disclosure. For example, in response to receiving input at the user-interactable element corresponding to the team 1001A, the system 100 can cause the user interface 1000B to display on the device from which the input was received. The interface 1000B shows user-interactable elements for presentations 1003A-D, shared with the team 1001A.

Aspects of this disclosure can be implemented in digital circuits, computer-readable storage media, as one or more computer programs, or a combination of one or more of the foregoing. The computer-readable storage media can be non-transitory, e.g., as one or more instructions of a computer program executable by one or more devices and stored on a tangible storage device.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more processors, causes the one or more processors to perform the one or more operations.

While operations shown in the drawings and recited in the claims are shown in a particular order, it is understood that the operations can be performed in different orders than shown, and that some operations can be omitted, performed more than once, and/or be performed in parallel with other operations. Further, the separation of different system components configured for performing different operations should not be understood as requiring the components to be separated. The components, modules, programs, and engines described can be integrated together as a single system, or be part of multiple systems.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A system comprising:
at least one processor configured to:
receive a primary presentation and at least one sub-presentation; and
generate a composite presentation from the primary presentation and the at least one sub-presentation, wherein the at least one processor links the primary presentation to the at least one sub-presentation and generates data for displaying the composite presentation, including data for displaying at least one display element in common across the primary presentation and the at least one sub-presentation.

2. The system of claim 1, wherein the at least one processor generates the data for displaying the composite presentation based on composite presentation display criteria specifying modifications to the at least one display element in common across the primary presentation and the at least one sub-presentation.

3. The system of claim 2, wherein the at least one processor displays, on a display device, at least a portion of the composite presentation according to the generated data and based on the one or more composite presentation display criteria.

4. The system of claim 3, wherein to display at least a portion of the composite presentation, the at least one processor:
receives a version of a sub-presentation of the at least one sub-presentation identified as the most recent version of the sub-presentation; and
displays the composite presentation using at least the generated data and the received version of the sub-presentation.

5. The system of claim 2, wherein the at least one display element for each of the at least one sub-presentation and the primary presentation is arranged according to a common template.

6. The system of claim 5, wherein the common template comprises a display element including a navigation bar, the navigation bar comprising one or more user-interactable elements for navigating between the at least one sub-presentation or the primary presentation in the composite presentation.

7. The system of claim 2,
wherein to generate data for displaying the composite presentation, the at least one processor modifies at least one sub-presentation in the composite presentation according to the one or more composite presentation display criteria.

8. The system of claim 7,
wherein the at least one processor receives, for at least one of the at least one sub-presentation, one or more sub-presentation display criteria specifying conditions for displaying content of the at least one sub-presentation; and
wherein to generate the data for displaying the composite presentation subject to the one or more composite presentation display criteria, the at least one processor:
determines that generating the data does not violate the one or more sub-presentation display criteria for the at least one sub-presentation, and
in response to the determination, generates data for displaying the composite presentation that does not violate the one or more sub-presentation display criteria for the at least one sub-presentation.

9. The system of claim 2,
wherein the at least one processor maintains, for each of the at least one sub-presentation, one or more respective permissions for generating a composite presentation comprising the at least one sub-presentation; and
wherein to generate the composite presentation, the at least one processor determines, for a first sub-presentation of the at least one sub-presentation, whether generating the composite presentation with the received sub-presentation violates one or more maintained permissions for the first sub-presentation.

10. The system of claim 9,
wherein the primary presentation and each of the at least one sub-presentation are authored by one or more respective users, and
wherein the one or more maintained permissions for the first sub-presentation indicate one or more permitted users for generating the composite presentation comprising the first sub-presentation.

11. The system of claim 2, wherein the at least one processor:
maintains a plurality of composite presentations for download;
receives a request to download a first composite presentation of the plurality of composite presentations; and
in response, sends data for displaying the first composite presentation to a display device.

12. The system of claim 11, wherein to link the primary presentation to at least one other sub-presentation, the at least one processor receives input indicating a position and a destination content presentation for a user-interactable presentation link in the composite presentation, wherein the user-interactable presentation link, in response to input, is configured to cause the at least one processor to display at least a portion of the destination content presentation specified in the input.

13. The system of claim 12, wherein the at least one processor:
maintains data corresponding to the composite presentation, specifying one or more of:
the number of times the composite presentation was a response to a request to download the composite presentation, and
the number of times the composite presentation was linked from another composite presentation of the maintained plurality of composite presentations.

14. A method, comprising:
receiving, by at least one processor, a primary presentation and at least one sub-presentation; and
generating, by the at least one processor, a composite presentation from the primary presentation and the at least one sub-presentation, comprising linking the primary presentation to the at least one sub-presentation and generating data for displaying the composite presentation, including data for displaying at least one display element in common across the primary presentation and the at least one sub-presentation.

15. The method of claim of 14, wherein generating the data for displaying the composite presentation comprises generating the data based on composite presentation display criteria specifying modifications to the at least one display element in common across the primary presentation and the at least one sub-presentation.

16. The method of claim 15, further comprising displaying, on a display device, at least a portion of the composite presentation according to the generated data and based on the one or more composite presentation display criteria.

17. The method of claim 16, wherein displaying at least a portion of the composite presentation comprises:
receiving a version of a sub-presentation of the at least one sub-presentation identified as the most recent version of the sub-presentation; and
displaying the composite presentation using at least the generated data and the received version of the sub-presentation.

18. The method of claim 15, wherein the at least one display element for each of the at least one sub-presentation and the primary presentation is arranged according to a common template.

19. The method of claim 18, wherein the common template comprises a display element including a navigation bar, the navigation bar comprising one or more user-interactable elements for navigating between the at least one sub-presentation or the primary presentation in the composite presentation.

20. A non-transitory computer-readable storage medium encoded with a computer program, the program comprising instructions that when executed by at least one processor, cause the at least one processor to perform operations comprising:
receiving a primary presentation and at least one sub-presentation; and
generating a composite presentation from the primary presentation and the at least one sub-presentation, wherein the at least one processor links the primary presentation to the at least one sub-presentation and generates data for displaying the composite presentation, including data for displaying at least one display element in common across the primary presentation and the at least one sub-presentation.
